(19) United States
(12) Patent Application Publication
(10) Pub. No.: US 2026/0186763 A1
(43) Pub. Date: Jul. 2, 2026

(54) Large Scale Operating System (OS) Upgrade

(71) Applicant: PayPal, Inc., San Jose, CA (US)

(72) Inventors: Muthukumar Koteeswaran, Chennai (IN); Amalarasan Jayaraman, San Jose, CA (US); Aihua Li, Cupertino, CA (US); Peter Chan, San Ramon, CA (US); Muthukumar Raja, Chennai (IN)

(21) Appl. No.: 19/091,009

(22) Filed: Mar. 26, 2025

(30) Foreign Application Priority Data
Dec. 30, 2024 (IN) 202411104673

(51) Int. Cl. G06F 8/65; G06F 8/61; G06F 11/14

(52) U.S. Cl. CPC G06F 8/65; G06F 8/63; G06F 11/1451; G06F 11/1469

(57) ABSTRACT

Techniques are disclosed for updating an operating system (OS) on a computing system. In some embodiments, a computer system receives an instruction to update a first operating system (OS) of the computer system to a second OS. The computer system loads the second OS into a volatile memory of the computer system and initiates a backup of the non-volatile memory of the computer system while the second OS is loaded into the volatile memory. In response to a completion of the backup, the computer system moves the second OS from the volatile memory to the non-volatile memory of the computer system. The computer system then boots the second OS from the non-volatile memory. This provides data integrity, minimizes risk of data loss, and reduces disruptions during the OS update process.

### PRIORITY CLAIM

The present application claims priority under 35 U.S.C. § 119 to Indian patent application IN 202411104673, filed Dec. 30, 2024, the disclosure of which is incorporated by reference herein in its entirety.

### BACKGROUND

### Technical Field

This disclosure relates generally to computer systems and, more specifically, to distributing operating systems updates.

### Description of the Related Art

Updating operating systems (OS) is a common practice in computer systems to address security vulnerabilities, ensure compatibility with evolving hardware and software, and introduce new features that enhance performance and user experience. Regular updates are recommended to mitigate emerging threats, fix software bugs, and maintain optimal system functionality. Traditional OS update processes can involve downloading and installing the new OS, which may temporarily interrupt operations but is necessary to ensure systems remain secure and up-to-date. Despite their importance, challenges such as minimizing downtime and ensuring seamless transitions between OS versions highlight the need for improvements to existing update mechanisms.

### BRIEF DESCRIPTION OF THE DRAWINGS

FIG. 1 is a block diagram illustrating an update system, according to some embodiments.

FIG. 2 is a block diagram illustrating a data backup and operating system update process, according to some embodiments.

FIG. 3 is a block diagram illustrating a data recovery process, according to some embodiments.

FIG. 4 is a block diagram illustrating an example of a web server hosting a user interface, according to some embodiments.

FIGS. 5A-5C are flow diagrams illustrating embodiments of methods implementing techniques described herein.

FIG. 6 is a block diagram illustrating elements of an exemplary computer system for implementing techniques described herein.

### DETAILED DESCRIPTION

In some cases, users may avoid updating their OS out of fear they may disrupt functionality, such as causing legacy software or hardware drivers to stop working or introducing system bugs. Restoring a prior OS after an update can also be difficult, sometimes requiring hard drive reformatting and risking data loss. These challenges may be particularly problematic in enterprise environments, where IT departments prioritize updates for security reasons but must balance this need with minimizing disruption. Some OS upgrade methods may involve downloading updates to non-volatile memory and relying on the existing OS for installation, which may lead to inefficiencies and risks of data corruption. These limitations highlight the need for alternative solutions that reduce disruptions and provide reliable recovery options. The techniques in the present disclosure thus provide a better solution for OS upgrades which, compared to other possible techniques, is faster, involves less system downtime, reduces data transfer and storage requirements, and lowers the risk of data loss, according to various embodiments. These techniques may be particularly advantage in enterprise scale environments with hundreds or even thousands of devices.

The present disclosure introduces techniques for updating operating systems that aim to address these challenges by enhancing data protection and minimizing disruption during the update process. In some embodiments, the system receives an instruction to update a first OS to a second OS. The second OS may initially be downloaded as an image (e.g., an ISO file) into non-volatile memory (e.g., a hard drive or solid-state drive). Following this, the system may reboot and load the second OS into volatile memory (e.g., RAM or volatile memory) for installation. During this stage, the system may unpack the image, apply updates (e.g., security patches or new capabilities), and prepare the OS for operation. While the second OS is loaded in volatile memory, the system may initiate a backup of the non-volatile memory (e.g., capturing user data, application files, and system settings including settings of the first OS). This backup can be stored locally within the computer system being updated or on a remote server located at a separate physical location, providing additional flexibility and security. To further protect the data, encryption may be applied to the backup before storage. After the backup is successfully completed and verified, the second OS may be moved from volatile memory to non-volatile memory for permanent installation. The second OS may be stored in a separate partition, distinct from the partition containing user data, which may facilitate efficient data management and recovery. Additionally, the system may validate the integrity of the second OS prior to storing it in non-volatile memory, ensuring that only verified files are used for installation. Finally, the system reboots again to boot the second OS from non-volatile memory as the active OS.

In some embodiments, the techniques described herein offer several advantages over other possible ways of performing an OS update. By temporarily loading, unpacking, and installing the second OS into volatile memory (e.g., RAM) during the installation process, the system may reduce the risk of premature modifications to non-volatile memory, thereby helping to prevent potential data corruption. This approach may allow the backup process to occur while the second OS is temporarily stored in volatile memory, optimizing resource allocation and minimizing system downtime during the update. Encryption and remote storage options for backups may enhance the security of user data throughout the process, addressing concerns related to data protection and recovery. The system may also provide features to improve usability and scalability, such as a web-based user interface that allows users or administrators to initiate and monitor updates remotely. In some embodiments, additional safeguards, such as compatibility checks performed before installation and logging mechanisms to record update progress, may enable a reliable and transparent update process. In the event of an update failure, the system may use the stored backup to restore the first OS and its associated data, enabling a robust recovery mechanism. By leveraging local storage for the backup within the computer system being updated, the techniques further minimize dependency on external systems. These features may collectively provide a flexible and reliable solution for managing OS updates, thereby addressing limitations in existing methods while meeting the requirements of diverse computing environments.

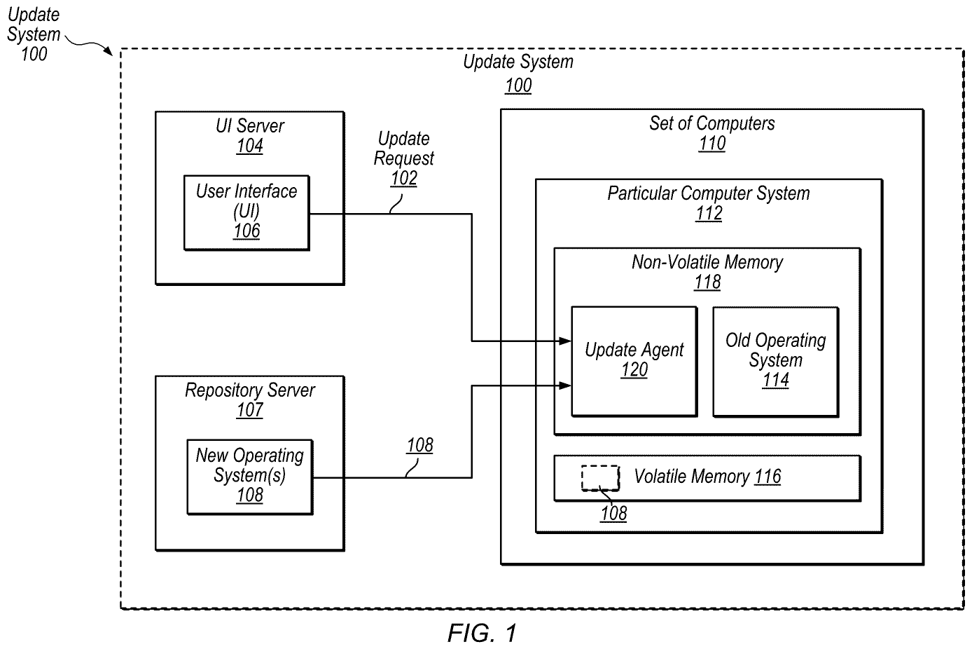

Turning now to FIG. 1, a block diagram of an update system 100 is depicted. In the illustrated embodiment of FIG. 1, update system 100 facilitates operating system (OS) updates across multiple computing devices. Update system 100 includes set of computers 110, user interface (UI) server 104, and repository server 107. These components interact to execute an update process by leveraging non-volatile memory 118 to temporarily store the image of new OS 108, perform a first reboot to load the image into volatile memory 116 for unpacking and installation, and non-volatile memory 118 for long-term storage following a second reboot.

In some embodiments, set of computers 110 includes one or more computer systems such as personal computers, workstations, and/or enterprise servers. Those skilled in the art will appreciate additional examples of computing systems within set of first computers 110. Each computer within set of computers 110 may be running its own respective OS. Particular computer system 112 represents a device targeted for an OS update. Particular computer system 112 includes two types of memory such as volatile memory 116 and non-volatile memory 118. Volatile memory 116 may represent temporary storage (e.g., such as random access memory (RAM)), that enables rapid access to data during operations. By contrast, non-volatile memory 118 may provide persistent storage (e.g., such as hard drives or solid-state drives (SSDs)), which can retain data even when the computing device is powered off. In some embodiments, non-volatile memory 118 stores old operating system 114, as well as an update agent 120 that manages and executes the OS update process.

Repository server 107 is one or more server computers that store new operating system(s) 108, which may include multiple OS versions. For example, different versions of new operating systems 108 may be curated for compatibility with the various computing devices in set of first computers 110. By way of example, these OS versions may be verified for functionality and integrity by administrative entities and/or users prior to deployment. In some embodiments, repository server 107 and UI server 104 can engage in bidirectional communication to facilitate the update process for computers 110. This interaction may include initiating specific OS updates, reporting the status of updates, and/or performing validation checks. By way of example, UI server 104 may generate an update request 102 for particular computer system 112 (e.g., the target device within set of computers 110 for the OS update). In response, repository server 107 may determine the appropriate version of the operating system from new operating systems 108 (e.g., for compatibility with particular computer system 112). Once identified, repository server 107 may transmit the selected OS version to update agent 120 of particular computer system 112 (e.g., as indicated by arrow 108). Although FIG. 1 illustrates update request 102 as an arrow going from UI server 104 to particular computer system 112 indicating that UI server 104 initiates the OS update, in other embodiments particular computer system 112 may initiate the OS update process (e.g., via update agent 120).

Non-volatile memory 118 (e.g., a hard drive or solid-state drive (SSD)) initially may store the image (e.g., an ISO file or another compressed format) of new OS 108 before the installation process begins. Once the image is downloaded to non-volatile memory 118, particular computer system 112, via update agent 120, modifies the boot image and triggers the first reboot to load the image into volatile memory 116 for unpacking and installation. During this phase, volatile memory 116 provides temporary storage, allowing particular computer system 112 to minimize potential disruptions to non-volatile memory 118. This approach ensures that no permanent modifications to non-volatile memory 118 occur until the update process has been validated. Non-volatile memory 118 also serves as persistent storage for the existing data of particular computer system 112. Examples of such data may include, but are not limited to, user data, application files, and/or system settings.

In some embodiments, the update process begins with particular computer system 112 (via update agent 120) downloading the selected OS version into non-volatile memory 118 from repository server 107. The update agent 120 then unpacks and installs the image of new OS 108 into volatile memory 116 for further processing. Once unpacking and installation are complete, particular computer system 112, via update agent 120, proceeds with a backup process. The downloaded OS may remain in volatile memory 116 during installation and backup steps until it is moved to non-volatile memory 118 for long-term storage.

After the backup process is completed, particular computer system 112 moves new OS 108 from volatile memory 116 to a designated partition within non-volatile memory 118 for permanent storage. The second reboot is triggered at this point to load new OS 108 from non-volatile memory 118 and transition it into the active operating system. Booting may include executing a boot loader (not illustrated in FIG. 1) stored in non-volatile memory 118, which prepares new OS 108 for operation by loading essential drivers, initializing system processes, and/or allocating memory resources. By leveraging non-volatile memory 118 for booting after the second reboot, particular computer system 112 maintains data integrity and ensures the reliability of the update process.

During the installation phase, particular computer system 112 (via update agent 120) may initiate a backup of its non-volatile memory 118. This backup operation may capture user data, configurations, and/or critical system files (e.g., providing a safeguard against potential data loss during the update process). In some embodiments, update agent 120 allocates resources to the backup process by prioritizing it for execution on the processor of particular computer system 112. By coordinating these operations efficiently, the backup process can run without significant disruption to other system functions. The backup data may be stored locally within a data partition of non-volatile memory 118, ensuring that it is immediately accessible for restoration if required. In some implementations, the backup data may also be transmitted to a remote server (e.g., not illustrated in FIG. 1) to provide redundancy and additional protection against hardware failures. Encryption may be applied to the backup before storage or transmission to enhance data security.

Once the backup of non-volatile memory 118 is successfully completed, particular computer system 112, via update agent 120, moves new OS 108 from volatile memory 116 to a designated partition within non-volatile memory 118 for permanent installation. This process ensures that new OS 108 is stored in a separate partition, such as a new OS partition distinct from the partition containing user data. Before completing the transfer, particular computer system 112 may verify the integrity of new OS 108 to confirm that no corruption occurred during the download or unpacking phases. The verification process may involve checksum calculations or digital signature verification to ensure that only validated and error-free files are installed. After these steps, particular computer system 112 triggers the second reboot, during which the boot loader stored in non-volatile memory 118 prepares new OS 108 for activation by loading essential drivers, initializing system processes, and configuring system resources. This two-step approach ensures that the transition to new OS 108 is both reliable and secure.

Following the second reboot, new OS 108 transitions to an active state within non-volatile memory 118, becoming the primary operating system for particular computer system 112. Update agent 120 facilitates this transition by configuring new OS 108 and ensuring compatibility with existing system resources. This may include transferring system settings, integrating new drivers, and verifying compatibility with hardware and software components. Once the installation is complete, particular computer system 112 may notify repository server 107 or a logging server to record the successful update, providing an auditable record of the operation. Metadata may also be updated to reflect the new operating system state, ensuring that administrative systems remain synchronized with the current OS version. This integrated approach enables update system 100 to efficiently manage OS updates while maintaining data integrity and operational reliability across diverse computing environments.

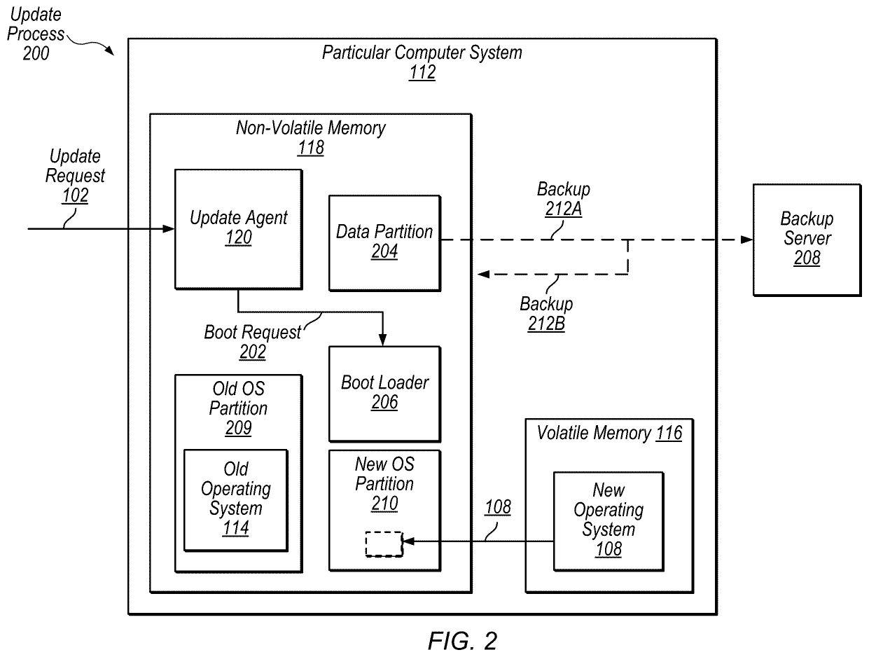

Turning now to FIG. 2, a block diagram illustrating a data backup process 200 associated with an OS update is depicted. In the illustrated embodiment of FIG. 2, particular computer system 112 is shown interacting with various internal components to manage an OS update and data backup operation. As described earlier in relation to FIG. 1, particular computer system 112 includes both non-volatile memory 118 and volatile memory 116, which together facilitate the OS update process. Additionally, FIG. 2 depicts the external backup server 208 as one possible destination for storing user data (represented as backup 212A) during the update process. Another embodiment, represented as backup 212B, involves storing the backup data locally within non-volatile memory 118.

In some embodiments, particular computer system 112 receives an update request 102, which can be processed by update agent 120 located within non-volatile memory 118. Update agent 120 may function as a coordinating entity that handles the update process. Upon receiving update request 102, update agent 120 initiates a sequence of operations such that the OS update is performed. For example, update agent 120 can transmit a boot request 202 to boot loader 206, which may also be stored in non-volatile memory 118. Boot loader 206 may play a role in preparing new OS 108 for execution. Specifically, boot loader 206 may manage the process of initializing new OS 108 stored temporarily in volatile memory 116 and transitioning it into a runnable state. Backup processes may also be triggered at this stage, as represented by backup 212A (to external backup server 208) or backup 212B (to a local data partition within non-volatile memory 118). This may include tasks such as verifying the integrity of new OS 108, loading essential drivers, and initializing system-level processes. The use of boot loader 206 may help decouple old operating system 114 from the OS update process, allowing new OS 108 to be loaded without interfering with the existing system configuration.

Non-volatile memory 118 within particular computer system 112 may include multiple partitions to segregate data and system components. These may include data partition 204, old OS partition 209, and new OS partition 210. Old OS partition 209 may include old operating system 114, which represents the currently installed OS on particular computer system 112. During the update process, data partition 204 may serve as a repository for user data, application settings, and other persistent information associated with old operating system 114. Before making any changes to non-volatile memory 118, update agent 120 may initiate a backup operation, such as backup 212A or backup 212B. In backup 212A, the contents of data partition 204 are transmitted to backup server 208, providing a safeguard against potential data loss during the update process. In backup 212B, the backup data is stored locally within non-volatile memory 118, eliminating the need for external storage while ensuring immediate accessibility for restoration if required. Backup server 208 or local storage in non-volatile memory 118 may store encrypted versions of the data to enhance security and ensure redundancy in case of hardware or software failures.

Boot loader 206 may play a role in transitioning new OS 108 from non-volatile memory 118 into an operational state following the second reboot. As part of this process, particular computer system 112 may initiate one of the backup operations represented by backup 212A or backup 212B. Backup 212A involves transmitting user data, configurations, and system files to external backup server 208, providing redundancy and protecting against local hardware failures. Alternatively, backup 212B involves storing the backup locally within non-volatile memory 118, specifically in a designated data partition, ensuring faster recovery without reliance on external systems. Boot loader 206 may manage the initialization of new OS 108 stored in non-volatile memory 118 by performing tasks such as verifying the integrity of new OS 108, loading essential drivers, and initializing system-level processes. The backup operation may occur during earlier phases of the update process, ensuring the system's state is preserved before transitioning to the newly installed operating system. By coordinating these tasks efficiently, boot loader 206 helps ensure a smooth transition while minimizing disruptions during the OS update process.

In some embodiments, backup server 208 may be located at a remote physical location, providing additional protection against localized hardware failures or environmental disruptions (e.g., such as power outages or natural disasters). For example, backup server 208 could be part of a cloud-based infrastructure, allowing the data to be distributed across multiple servers for enhanced availability and fault tolerance. Alternatively, backup 212B stored locally in non-volatile memory 118 may provide faster access and lower latency for restoration processes, reducing reliance on external systems.

The new operating system 108 is initially downloaded to non-volatile memory 118 as an image (e.g., ISO or similar compressed format). During the update process, this image is unpacked and temporarily loaded into volatile memory 116 for installation and validation steps. Following the backup process (represented as backup 212A or backup 212B), new operating system 108 is moved into new OS partition 210 within non-volatile memory 118, as indicated by the arrow leading to the dashed box inside new OS partition 210. This movement represents the transition of new operating system 108 from temporary storage in volatile memory 116 to permanent storage in non-volatile memory 118. The dashed representation within new OS partition 210 highlights the allocation of dedicated space for new OS 108, ensuring it does not overwrite or conflict with existing partitions, such as old OS partition 209 or data partition 204. This arrangement helps maintain data integrity and enables a reliable transition to the updated operating system after the second reboot.

In some embodiments, before the installation of new OS 108 is finalized, particular computer system 112 may validate its integrity to ensure the update is successful and free from errors. This validation may occur during multiple stages of the update process, such as after new OS 108 is unpacked into volatile memory 116 and before it is moved to non-volatile memory 118. For example, the validation process may involve performing checksum calculations, where a unique hash value is generated and compared to a pre-calculated value associated with new OS 108 to detect potential corruption during download, unpacking, or transfer. Additionally, redundancy checks, digital signatures, or similar mechanisms may be used to authenticate new OS 108 and verify compatibility with particular computer system 112. By ensuring that only verified and intact files are written to new OS partition 210, this validation process prevents the installation of corrupted or incomplete files, maintaining the reliability and integrity of the update process.

In some embodiments, the final stages of the update process involve configuring new operating system 108 for long-term use. For instance, update agent 120 may oversee tasks such as transferring system settings, integrating new drivers, or verifying compatibility with particular computer system 112's hardware and software components. Once fully installed, new operating system 108 becomes the active OS, replacing old operating system 114. At this point, particular computer system 112 may generate a status notification or log entry, which can be transmitted to backup server 208 or another administrative system to record the successful update.

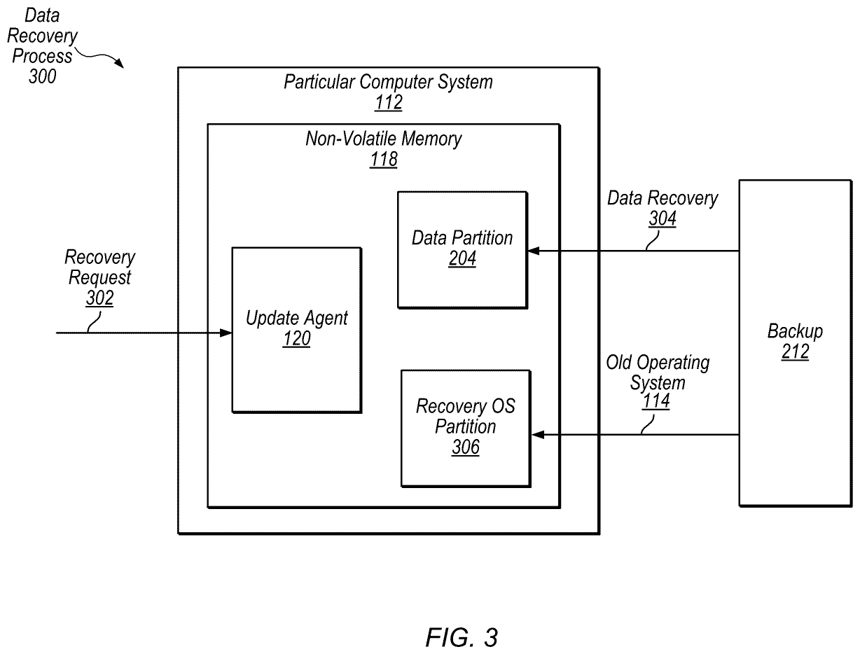

Turning now to FIG. 3, a block diagram illustrating a data recovery process 300 is depicted. In the illustrated embodiment of FIG. 3, particular computer system 112 retrieves a backup 212, which may be obtained from local storage or a backup server 208 to facilitate recovery operations. The recovery process may be initiated in response to a request to restore a prior OS and/or recover associated data.

As shown in FIG. 3, data recovery process 300 uses components, which include update agent 120, data partition 204, and recovery OS partition 306. Update agent 120 may function as a control entity for managing the recovery process. Upon receiving recovery request 302 (e.g., generated by a user or administrator), update agent 120 may initiate the steps to restore the particular computer system's OS to a previous state. Recovery request 302 may indicate a need to revert to a prior OS, such as old operating system 114, and/or restore user data from a backup.

Non-volatile memory 118 within particular computer system 112 is partitioned into distinct regions to support the recovery process. Data partition 204 can store user data, application settings, and/or system configurations associated with the previous OS (e.g., old OS 114). Recovery OS partition 306 can serve as a dedicated partition within non-volatile memory 118 for storing the restored OS (e.g., old OS 114). In some embodiments, this segregation of data partition 204 and recovery OS partition 306 may provide operational integrity by preventing overwrites or conflicts during the recovery process.

Data recovery 304 facilitates the retrieval of user data and application files from backup 212 to data partition 204. Backup 212 may store copies of the user data that were previously backed up during an earlier OS update process, as described in FIG. 2. Data recovery 304 may ensure that critical information such as user documents, preferences, and/or application-specific data are reinstated to data partition 204, thereby maintaining consistency between the restored OS and user expectations. In some embodiments, data recovery 304 may include encrypted data to secure sensitive information during the restoration process. In some embodiments, backup 212 may not include user data from data partition 204 (e.g., backup 212 may only include prior OS data and any other data necessary to facilitate a data recovery process 300).

As illustrated in FIG. 3, old OS 114 is restored via arrow 114 into recovery OS partition 306. This restoration allows old OS 114 to be staged in recovery OS partition 306 for reinstallation on particular computer system 112. In some embodiments, old OS 114 may be verified for integrity by update agent 120 to ensure it has not been corrupted. Examples of such verification may include, but are not limited to, checksums, digital signatures, or other cryptographic methods. Those skilled in the art will appreciate additional examples of verification methods.

In some cases, after old OS 114 and user data are successfully restored, update agent 120 may oversee the final stages of the recovery process. For instance, update agent 120 may configure recovery OS partition 306 to serve as the active OS partition and ensure compatibility with data partition 204. Additionally, update agent 120 may validate that all necessary system files and/or user data have been successfully restored before completing the recovery process. In some cases, update agent 120 may notify a log server of the successful recovery, creating a log entry for administrative purposes.

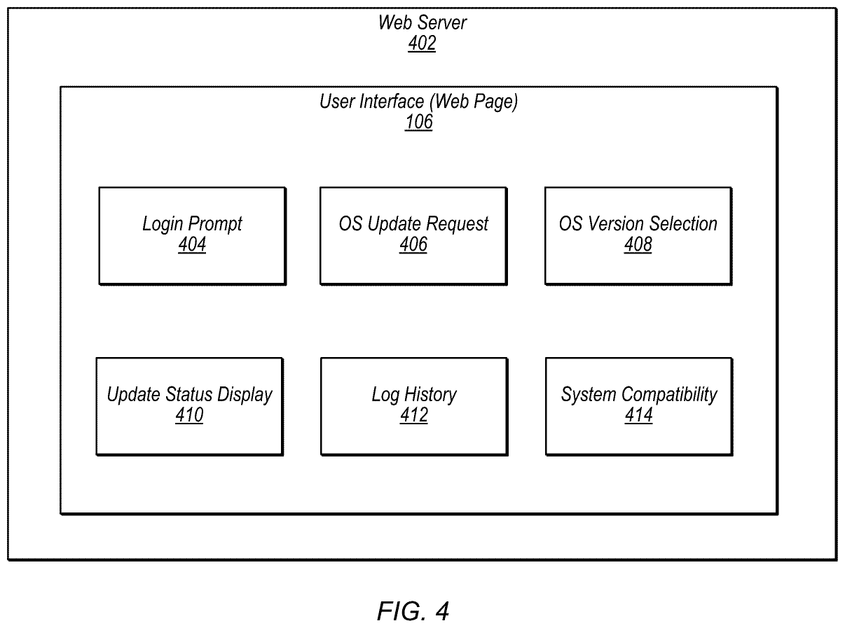

Turning now to FIG. 4, a block diagram illustrating an example of a web server 402 hosting a user interface 106 is depicted. In the illustrated embodiment of FIG. 4, web server 402 provides a user interface 106, which may be implemented as a web page accessible to users or administrators. In some embodiments, user interface 106 may correspond to the interface hosted by UI server 104, as described above in relation to FIG. 1, enabling users to interact with update system 100. User interface 106 may facilitate various functionalities related to initiating, managing, and monitoring OS updates across set of first computers 110.

User interface 106 includes several components to related to the OS update process. Login prompt 404 may provide an authentication mechanism for users and/or administrators to securely access the system (e.g., UI server 104). In some embodiments, login prompt 404 may require user credentials including, but not limited to, usernames, passwords, and/or multi-factor authentication tokens to ensure secure access. Once authenticated, the user may proceed to manage OS updates using other features of user interface 106.

User interface 106 includes OS update request 406, which may allow users to initiate OS updates for one or more computers within set of first computers 110. For instance, OS update request 406 may provide options to specify which devices should receive updates or to apply updates to the entire set of first computers 110. This feature may support scheduling updates at specific times to minimize disruption to ongoing operations. Additionally, OS version selection 408 may enable users to choose from a list of available OS versions (e.g., curated and stored in repository server 107). For instance, OS version selection 408 may display a dropdown menu or other interactive elements, allowing users to select a compatible OS version based on the specific requirements of a targeted computer system (e.g., particular computer system 112).

In some instances, to provide transparency during the update process, user interface 106 may include an update status display 410, which may represent the progress of OS updates for one or more computers within set of first computers 110. For example, update status display 410 may show real-time progress bars, percentage completion, and/or other visual indicators for each computer receiving an update. In some embodiments, update status display 410 may also provide detailed status messages, such as “Backup in Progress,” “Downloading OS,” or “Update Completed,” to inform users about the current stage of the OS update process.

User interface 106 can include a log history 412 feature, which may maintain a record of past OS updates (e.g., for auditing or troubleshooting purposes). For instance, log history 412 may display details such as the date and time of updates, the OS versions applied, and any errors encountered during the OS update process.

To determine compatibility between selected OS versions and the targeted computer systems, user interface 106 may include a system compatibility 414 feature. In some embodiments, system compatibility 414 can perform automated checks to verify that the selected OS version is compatible with the hardware and software configuration of the targeted computer. For example, this feature may evaluate factors such as processor architecture, available memory, and existing system configurations to prevent compatibility issues. In cases where compatibility issues are detected, system compatibility 414 may provide recommendations or alternative OS versions to resolve the issue.

Web server 402 hosting user interface 106 may also support remote access, enabling administrators to manage OS updates from any location with network connectivity. For example, this flexibility may enhance the usability of update system 100 by allowing centralized management of OS updates for distributed computing environments.

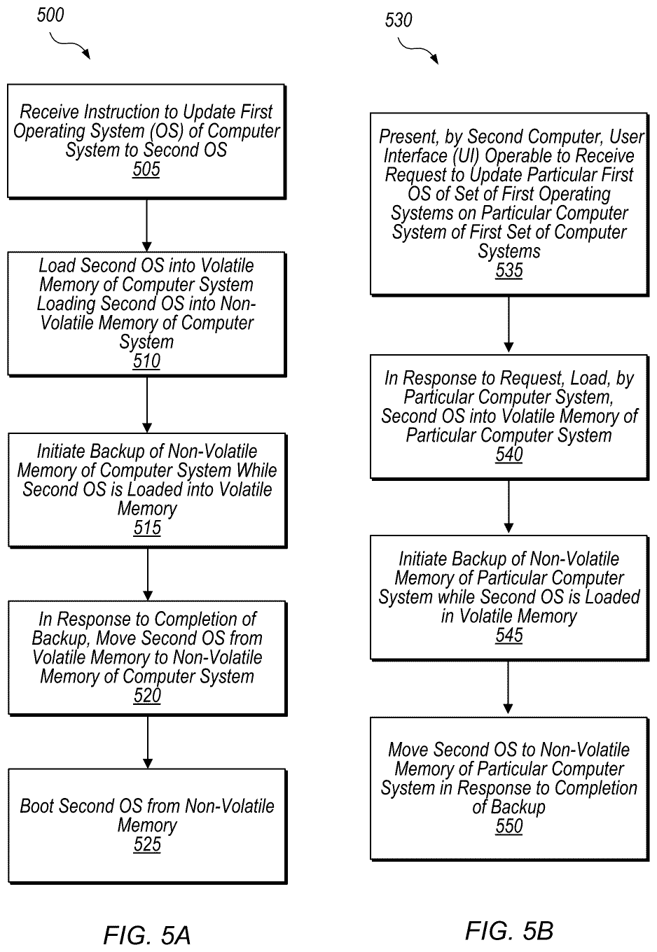

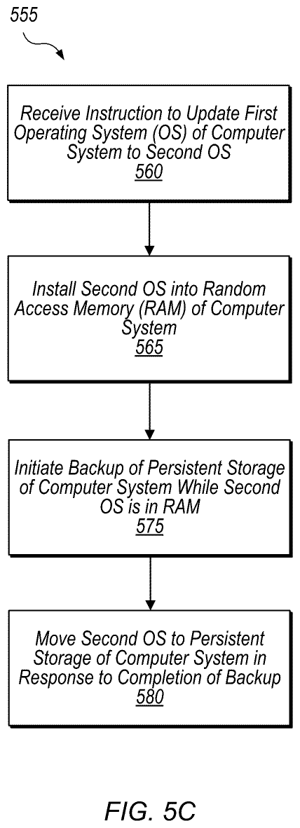

Turning now to FIG. 5A, a flow diagram of a method 500 is shown. Method 500 is one embodiment of a method performed by a computer system (e.g., computing system 600, particular computer system 112). Method 500 may be performed by executing a set of program instructions stored on a non-transitory computer-readable medium.

Method 500 begins in step 505 with the computer system receiving an instruction to update a first operating system (OS) of the computer system to a second OS. For example, particular computer system 112, as illustrated in FIG. 1, may receive update request 102 via update agent 120, which may process the instruction to update old operating system 114 (i.e., the first OS) to new operating system 108 (i.e., the second OS). In some embodiments, this instruction may be generated by UI server 104 or server computer 107 and transmitted to particular computer system 112 through a networked connection.

In step 510, the computer system loads the second OS into a volatile memory of the computer system without loading the second OS into a non-volatile memory of the computer system. For example, the loading may include unpacking a downloaded image (e.g., downloaded from repository server 107) of the second operating system into the volatile memory and applying one or more updates to the second operating system, which may patch security vulnerabilities, add new functionality, etc. These updates may be downloaded from the repository server 107 providing the image or an update server provided by a developer of the second OS. This approach may allow existing data, including old OS 114 and user data in data partition 204, to remain unaltered during the early stages of the OS update.

In step 515, the computer system initiates a backup of the non-volatile memory of the computer system while the second OS is loaded into the volatile memory. This backup may include data as well as the old OS, which may reside in separate data and OS partitions.

In step 520, the computer system moves the second OS from the volatile memory to the non-volatile memory of the computer system in response to a completion of the backup. For example, particular computer system 112 may transfer the second OS (e.g., new OS 108) from volatile memory 116 to a designated partition (e.g., new OS partition 210) within non-volatile memory 118 after the backup (e.g., to backup server 208) of data partition 204 is successfully completed.

In step 525, the computer system boots the second OS from the non-volatile memory. For example, particular computer system 112 may execute boot loader 206 to initialize the second OS (e.g., new OS 108) directly from non-volatile memory 118. During this process, boot loader 206 may load essential drivers, allocate resources, and/or initialize system-level processes required for the second OS to operate. This approach may leverage volatile memory 116 to execute the second OS without modifying non-volatile memory 118, which may preserve the integrity of old OS 114 and other existing data.

In some embodiments, initiating the backup of the non-volatile memory of the computer system further comprises storing the backup of the non-volatile memory on a remote backup server located at a different physical location than the computer system. For example, particular computer system 112 may transmit a backup of data partition 204 to backup server 208, which may be located in a remote data center or cloud infrastructure. In other embodiments, initiating the backup of the non-volatile memory of the computer system further comprises storing the backup locally such as within the non-volatile memory. In some embodiments, the loading includes unpacking a downloaded image of the second operating system into the volatile memory and applying one or more updates to the second operating system. For example, the system may decompress the downloaded image, expand it into the memory structure required for operation, and apply updates such as security patches, bug fixes, or feature enhancements, ensuring the second operating system is configured correctly prior to installation.

In some embodiments, the computer system maintains a data partition that stores user data, the backup includes the user data, the moving includes moving the second OS to another partition of the non-volatile memory, and the other partition is distinct from the data partition. For example, particular computer system 112 may store user data in data partition 204 within non-volatile memory 118, back up this data to backup server 208, and subsequently write the second OS (e.g., new OS 108) to a separate new OS partition 210, such that the user data in data partition 204 remains unaffected.

In some embodiments, the computer system receives a request for a recovery process to restore the first OS and in response to the request retrieves the backup of the non-volatile memory and restores the first OS and associated data to the non-volatile memory from the retrieved backup. For example, particular computer system 112 may receive a recovery request 302 via update agent 120, retrieve (e.g., as shown by data recover 304 in FIG. 3) the backup of data partition 204 from backup server 208, and restore old OS 114 and associated user data to non-volatile memory 118, such that the particular computer system 112 is returned to its prior OS.

In some embodiments, initiating a backup of the non-volatile memory of the computer system comprises encrypting the backup of the non-volatile memory prior to storage. For example, particular computer system 112 may, while running second OS (e.g., new OS 108) from volatile memory 116, initiate a backup of data partition 204 and apply encryption to the backup data before transmitting it to backup server 208.

In some embodiments, moving the second OS to the non-volatile memory comprises verifying the integrity of the second OS prior to storing it in the non-volatile memory. For example, particular computer system 112 may perform a verification process (e.g., such as checksum validation or digital signature authentication) on the second OS (e.g., new OS 108) stored in volatile memory 116 before transferring it to new OS partition 210 within non-volatile memory 118, such that only an uncorrupted and authentic OS is installed.

In some embodiments, the computer system, in response to successfully updating the first OS to the second OS, notifies a logging server to create a log entry indicating the successful updating. For example, particular computer system 112, upon successfully transitioning to the second OS (e.g., new OS 108), may send a notification via update agent 120 to a logging server, which may record a log entry documenting the completion of the update process and any relevant details (e.g., such as timestamps and OS version identifiers).

In some embodiments, the computer system receiving an instruction to update a first operating system (OS) of the computer system to a second OS further includes receiving the instruction from a server computing system that presents a user interface (UI) to a user of the computer system. For example, particular computer system 112 may receive the update instruction from UI server 104, which can present a user interface 106 (e.g., a web page hosted by web server 402) allowing the user to initiate the update process and select the desired OS version.

Turning now to FIG. 5B, a flow diagram of a method 530 is shown. Method 530 is one embodiment of a method performed by a computer system (e.g., computing system 600, particular computer system 112) and may be performed by executing a set of program instructions stored on a non-transitory computer-readable medium.

Method 530 begins in step 535, where a second computer is configured to present a user interface (UI) that is operable to receive a request to update a particular first OS of the set of first operating systems on a particular computer system of the first set of computer system. For example, UI server 104 may present user interface 106 (e.g., hosted by web server 402) that enables a user to submit a request to update the operating system on particular computer system 112 (e.g., selecting an OS version via OS version selection 408 and initiating the update using OS update request 406).

In step 540, the computer system (e.g., particular computer system 112) is configured to, in response to the request, load a second OS into a volatile memory of the particular computer system. For example, an update agent 120 may unpack the second operating system from an image downloaded from a repository and apply one or more security updates to the unpacked second operating system, all without modifying non-volatile memory 118.

In step 545, the computer system may then initiate a backup of a non-volatile memory of the particular computer system while the second OS is loaded in the volatile memory. For example, while the second OS (e.g., new OS 108) is being unpacked and updated, particular computer system 112 may initiate a backup operation to transfer data from data partition 204 within non-volatile memory 118 to backup server 208 (e.g., via data backup 212 as shown in FIG. 2).

In step 550, the computer system may then move the second OS to the non-volatile memory of the particular computer system in response to completion of the backup. For example, after the backup of data partition 204 is successfully completed, particular computer system 112 may transfer the second OS (e.g., new OS 108) from volatile memory 116 to a designated partition (e.g., new OS partition 210) within non-volatile memory 118 for permanent installation.

In some embodiments, the particular computer system is configured to verify a compatibility of the second OS with the particular computer system prior to loading the second OS into the volatile memory. For example, particular computer system 112 may execute a compatibility check (e.g., using update agent 120) to ensure that the second OS (e.g., new OS 108) is suitable for the hardware and software configuration of the particular computer system 112 (e.g., verifying processor architecture, available memory, and existing drivers) before booting the second OS from volatile memory 116.

In some embodiments, the UI is a is a web-page hosted by the second computer and accessible by a web browser. For example, the UI (e.g., user interface 106) may be implemented as a web page hosted by UI server 104, and accessed via a web browser on a user device, enabling users to initiate OS updates, monitor update progress, and/or manage compatibility checks for particular computer system 112.

Turning now to FIG. 5C, a flow diagram of a method 555 is shown. Method 555 is one embodiment of a method performed by a computer system (e.g., computing system 600, particular computer system 112) and may be performed by executing a set of program instructions stored on a non-transitory computer-readable medium.

Method 555 begins in step 560 with the computer system receiving an instruction to update a first operating system (OS) of the computer system to a second OS. For example, particular computer system 112 may receive an instruction to update old operating system 114 to new OS 108 via update agent 120, based on a user-initiated request through a UI (e.g., hosted on UI server 104) or a command from repository server 107.

In step 565, the computer system installs the second OS into a random access memory (RAM) of the computer system. For example, particular computer system 112 may download an image of the second OS (e.g., new OS 108) from repository server 107, unpack the second OS from the image into volatile memory 116 (e.g., implemented as RAM), configure components (e.g., drivers and initialization routines), apply one or more security updates to the unpacked second operating system while allowing the existing data, including old OS 114, to remain unaltered during the install process.

In step 570, the computer system initiates a backup of the persistent storage of the computer system while the second OS is in RAM. For example, particular computer system 112 may initiate a backup of its persistent storage (e.g., non-volatile memory 118) to backup server 208 while the second OS (e.g., new OS 108) is actively running and capturing user data, application settings, and system files to ensure data integrity during the update process.

In step 575, the computer system moves the second OS to the persistent storage of the computer system in response to a completion of the backup. For example, particular computer system 112 may transfer the second OS (e.g., new OS 108) from volatile memory 116 to a designated partition within persistent storage (e.g., new OS partition 210 in non-volatile memory 118) after confirming the successful completion of the backup operation.

### Exemplary Computer System

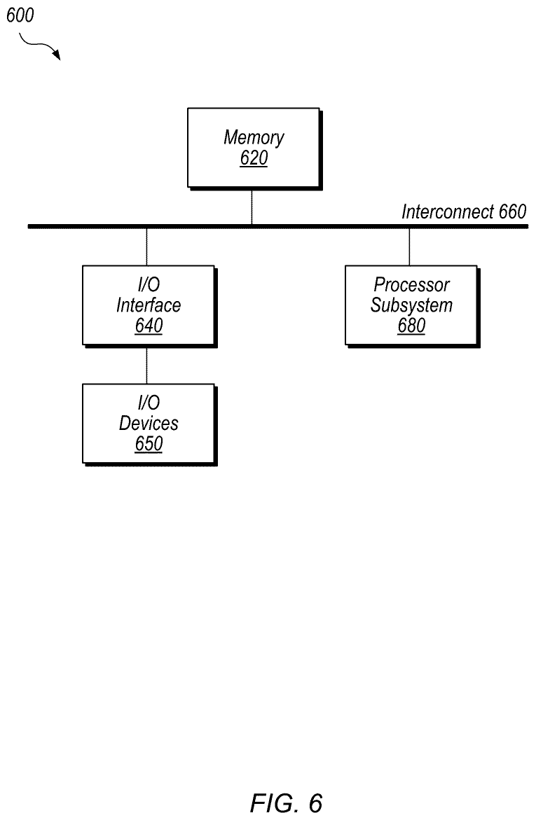

Turning now to FIG. 6, a block diagram of an exemplary computer system 600, which may implement update system 100 (e.g., or one or more components included in update system 100 such as set of first computers 110), is depicted. Computer system 600 includes a processor subsystem 680 that is coupled to a system memory 620 and I/O interfaces(s) 640 via an interconnect 660 (e.g., a system bus). I/O interface(s) 640 is coupled to one or more I/O devices 650. Although a single computer system 600 is shown in FIG. 6 for convenience, system 600 may also be implemented as two or more computer systems operating together.

Processor subsystem 680 may include one or more processors or processing units. In various embodiments of computer system 600, multiple instances of processor subsystem 680 may be coupled to interconnect 660. In various embodiments, processor subsystem 680 (or each processor unit within 680) may contain a cache or other form of on-board memory.

System memory 620 is usable store program instructions executable by processor subsystem 680 to cause system 600 perform various operations described herein. System memory 620 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 600 is not limited to primary storage such as memory 620. Rather, computer system 600 may also include other forms of storage such as cache memory in processor subsystem 680 and secondary storage on I/O Devices 650 (e.g., a hard drive, storage array, etc.). In some embodiments, these other forms of storage may also store program instructions executable by processor subsystem 680. In some embodiments, program instructions that when executed implement elements of systems 100 or 400 (e.g., elements 130, 140, 170, 420, 430, etc.) may be included/stored within system memory 620.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices 650 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 650 (e.g., configured to communicate over Wi-Fi®, Bluetooth®, Ethernet, etc.).

### ***

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A non-transitory computer-readable medium having program instructions stored thereon that are capable of causing a computer system to perform operations comprising:
receiving an instruction to update a first operating system (OS) of the computer system to a second OS;
loading the second OS into a volatile memory of the computer system without loading the second OS into a non-volatile memory of the computer system;
initiating a backup of the non-volatile memory of the computer system while the second OS is loaded into the volatile memory;
in response to a completion of the backup, moving the second OS from the volatile memory to the non-volatile memory of the computer system; and
booting the second OS from the non-volatile memory.

2. The non-transitory computer-readable medium of claim 1, wherein the loading includes:
unpacking a downloaded image of the second OS into the volatile memory; and
applying one or more updates to the second OS.

3. The non-transitory computer-readable medium of claim 2, wherein the operations further comprise:
prior to loading the second OS into the volatile memory, downloading the image from an external repository and into the non-volatile memory.

4. The non-transitory computer-readable medium of claim 1, wherein the operations further comprise:
maintaining a data partition that stores user data, wherein the backup includes the user data, wherein moving includes moving the second OS to another partition of the non-volatile memory, wherein the other partition is distinct from the data partition.

5. The non-transitory computer-readable medium of claim 1, wherein the operations further comprise:
receiving a request for a recovery process to restore the first OS;
in response to the request:
retrieving the backup of the non-volatile memory; and
restoring the first OS and associated data to the non-volatile memory from the retrieved backup.

6. The non-transitory computer-readable medium of claim 1, wherein the initiating further comprises:
encrypting the backup of the non-volatile memory prior to storage.

7. The non-transitory computer-readable medium of claim 1, wherein moving the second OS to the non-volatile memory further comprises:
verifying an integrity of the second OS prior to storing it in the non-volatile memory.

8. The non-transitory computer-readable medium of claim 1, wherein the operations further comprise:
in response to successfully updating the first OS to the second OS:
notifying a logging server to create a log entry indicating the successful updating.

9. The non-transitory computer-readable medium of claim 1, wherein the receiving further includes:
receiving the instruction from a server computing system that presents a user interface (UI) to a user of the computer system.

10. The non-transitory computer-readable medium of claim 1, wherein the operations further comprise:
storing the backup within a partition of non-volatile memory in the computer system.

11. A system comprising:
a first set of computer systems that include a corresponding set of first operating systems (OS);
a second computer configured to present a user interface (UI) that is operable to receive a request to update a particular first OS of the set of first operating systems on a particular computer system of the first set of computer systems;
wherein the particular computer system is configured to:
in response to the request, loading a second OS into a volatile memory of the particular computer system;
initiate a backup of a non-volatile memory of the particular computer system while the second OS is loaded in the volatile memory; and
move the second OS to the non-volatile memory of the particular computer system in response to completion of the backup.

12. The system of claim 11, wherein the particular computer system is further configured to:
verify a compatibility of the second OS with the particular computer system prior to loading the second OS into the volatile memory.

13. The system of claim 11, wherein the UI is a web-page hosted by the second computer and accessible by a web browser.

14. The system of claim 11, wherein the particular computer system is further configured to:
receive a request to restore the particular first OS on the particular computer system;
in response to the request:
retrieve the backup of the non-volatile memory; and
restore the particular first OS and associated data to the non-volatile memory from the retrieved backup.

15. A computer-implemented method comprising:
receiving an instruction to update a first operating system (OS) of a computer system to a second OS;
installing the second OS into a random access memory (RAM) of the computer system;
initiating a backup of a persistent storage of the computer system while the second OS is in RAM; and
moving the second OS to the persistent storage of the computer system in response to a completion of the backup.

16. The computer-implemented method of claim 15, wherein initiating the backup of the persistent storage of the computer system further comprises:
storing the backup of the persistent storage on a remote backup server located at a different physical location than the computer system.

17. The computer-implemented method of claim 15, wherein the installing includes:
unpacking the second OS from an image downloaded from a repository; and
applying one or more security updates to the unpacked second OS.

18. The computer-implemented method of claim 15 further comprising:
maintaining a data partition that stores user data, wherein the backup includes the user data, wherein moving includes moving the second OS to a new partition of the persistent storage, wherein the new partition is distinct from the data partition.

19. The computer-implemented method of claim 15 further comprising:
receiving a request for a recovery process to restore the first OS;
in response to the request:
retrieving the backup of the persistent storage; and
restoring the first OS and associated data to the persistent storage from the retrieved backup.

20. The computer-implemented method of claim 15, wherein the receiving further includes:
receiving the instruction from a server computing system that presents a user interface (UI) to a user of the computer system.
